(19) United States
(12) Patent Application Publication
(10) Pub. No.: US 2016/0071427 A1
(43) Pub. Date: Mar. 10, 2016

(54) SYSTEM AND METHOD FOR TEACHING HANDWRITING

(71) Applicants: Carrie Davis, Denville, NJ (US); Michele Parkins, Denville, NJ (US)

(72) Inventors: Carrie Davis, Denville, NJ (US); Michele Parkins, Denville, NJ (US)

(21) Appl. No.: 14/847,079

(22) Filed: Sep. 8, 2015

Related U.S. Application Data
(60) Provisional application No. 62/047,680, filed on Sep. 9, 2014.

(51) Int. Cl. G09B 11/00; G09B 11/04

(52) U.S. Cl. CPC G09B 11/00; G09B 11/04

(57) ABSTRACT

The present teachings are directed towards a method of teaching handwriting to a student. The method can include playing a first audio cue from a plurality of different audio cues. Each audio cue can include at least one musical note and can correspond to a specific one of a plurality of letter formation strokes. The method can include instructing the student to perform a first movement in response to the student hearing the first audio cue. The first movement can correspond to a first one of the letter formation strokes.

### CROSS-REFERENCE TO RELATED APPLICATIONS

This application claims the benefit of U.S. Provisional Application No. 62/047680, filed on Sep. 9, 2014, the entire disclosure of which is incorporated herein by reference.

### FIELD

The present disclosure relates to a system and method for teaching handwriting.

### BACKGROUND

This section provides background information related to the present disclosure which is not necessarily prior art.

Handwriting generally includes a person holding a writing instrument or utensil (e.g. pen, pencil, stylus, crayon, marker, paintbrush, chalk, etc.) in the person's hand and manipulating the instrument to mark a writing surface (e.g. paper, chalkboard, canvas, computer screen, etc.) with letters that can make up words and phrases. Handwriting is typically taught by having a student hold the writing utensil and practice marking the letters on the writing surface.

The letters are typically broken down into specific letter formation strokes or paths that the student can move the writing instrument through to form the letter. For example, the capital letter “D” can be formed by the student making a vertical stroke down, followed by a curved stroke from the top to the bottom.

Some students, especially younger or developmentally challenged students, can have difficulty controlling the fine motor skills necessary to hold and manipulate the writing instrument. Furthermore, it has been found that children follow a specific progression of line formation as they learn to scribble and write, starting with vertical and horizontal lines, followed by curved lines, and finally diagonal lines. Accordingly, the process of learning handwriting solely through practice with the writing instrument can be difficult, frustrating, and time consuming.

### SUMMARY

This section provides a general summary of the disclosure, and is not a comprehensive disclosure of its full scope or all of its features.

The present teachings are directed towards a method of teaching handwriting to a student. The method can include playing a first audio cue from a plurality of different audio cues. Each audio cue can include at least one musical note and can correspond to a specific one of a plurality of letter formation strokes. The method can include instructing the student to perform a first movement in response to the student hearing the first audio cue. The first movement can correspond to a first one of the letter formation strokes.

The present teachings are further directed towards a method of teaching handwriting to a student. The method can include introducing the student to an alphabet letter. The method can include introducing the student to a set of audio cues. Each audio cue can correspond to one of a set of handwriting formational strokes of the alphabet letter and can include at least one musical note. The method can include introducing the student to a set of body movements simultaneously with the set of audio cues. Each body movement can involve at least a whole upper body of the student and can mimic the handwriting formational strokes of the alphabet letter. Each of the audio cues can correspond to one of the body movements. The method can include instructing the student to perform a corresponding one of the body movements when the student hears a corresponding one of the audio cues. The method can include playing the set of audio cues while the student performs the body movements.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an example of an alphabet, illustrating English letters A-Z in capital and lowercase format;

FIG. 2 is a chart illustrating a letter learning sequence, letter templates, and letter formation strokes for the capital letters of FIG. 1;

FIG. 3 is a chart illustrating a letter learning sequence, letter templates, and letter formation strokes for the lower case letters of FIG. 1;

FIG. 4 is an example of a musical scale, illustrating musical notes A₃ through A₄;

FIG. 5 is an example pairing of musical notes to the letter formation strokes of the capital letters of FIG. 2;

FIG. 6A is a portion of an example pairing of musical notes to the letter formation strokes of the lowercase letters of FIG. 3;

FIG. 6B is the remaining portion of the example pairing of FIG. 6A;

FIG. 7 is a method of teaching handwriting in flow chart format;

FIG. 8 is an example pairing of body movement and musical notes;

FIG. 9 is an example pairing of finger movement and musical notes;

FIG. 10 is an example pairing of handwriting and musical notes;

FIG. 11 is an example of a progressive letter template; and

FIG. 12 is an example of a progressive word template.

Corresponding reference numerals indicate corresponding parts throughout the several views of the drawings.

### DETAILED DESCRIPTION

Example embodiments will now be described more fully with reference to the accompanying drawings.

The present teachings are directed toward a system and method of teaching handwriting that begins with a student tracing the shape of letters by moving his/her whole body, progresses to the student tracing the shape of the letters by moving only one of his/her arms, and finishes with the student writing the letters on a writing surface with a handwriting instrument. The method matches specific letter formation strokes with specific musical pitch changes to create an auditory correlation between the musical pitch changes and specific spatial movements. The method pairs specific letters with specific letter templates that have landmarks, that do not create the entire letter, to require the student to think about the shape of the letter. Thus, the system and method uses a multi-sensory approach to teaching handwriting.

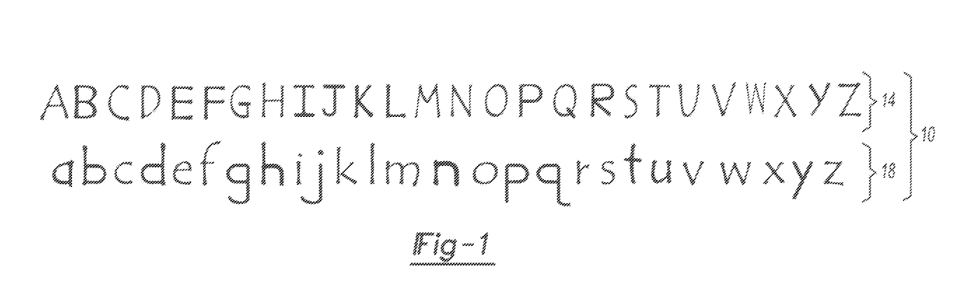

With reference to FIG. 1, an example of an alphabet 10 is shown. The alphabet 10 can include upper case or capital letters 14 and lower case letters 18. In the example provided, the alphabet 10 is a modern Roman or Latin alphabet used in the English language. The alphabet 10 can have characters or letters A through Z in the standard alphabetical order of A-B-C-D-E-F-G-H-I-J-K-L-M-N-O-P-Q-R-S-T-U-V-W-X-Y-Z. It is understood that the present teachings can apply to other languages or alphabets. For example, the Spanish, or German languages can include additional letters such as “II” or “B” respectively. In the example provided, the alphabet 10 is shown in a font typical of beginning handwriting, but other styles or fonts of letters can be used.

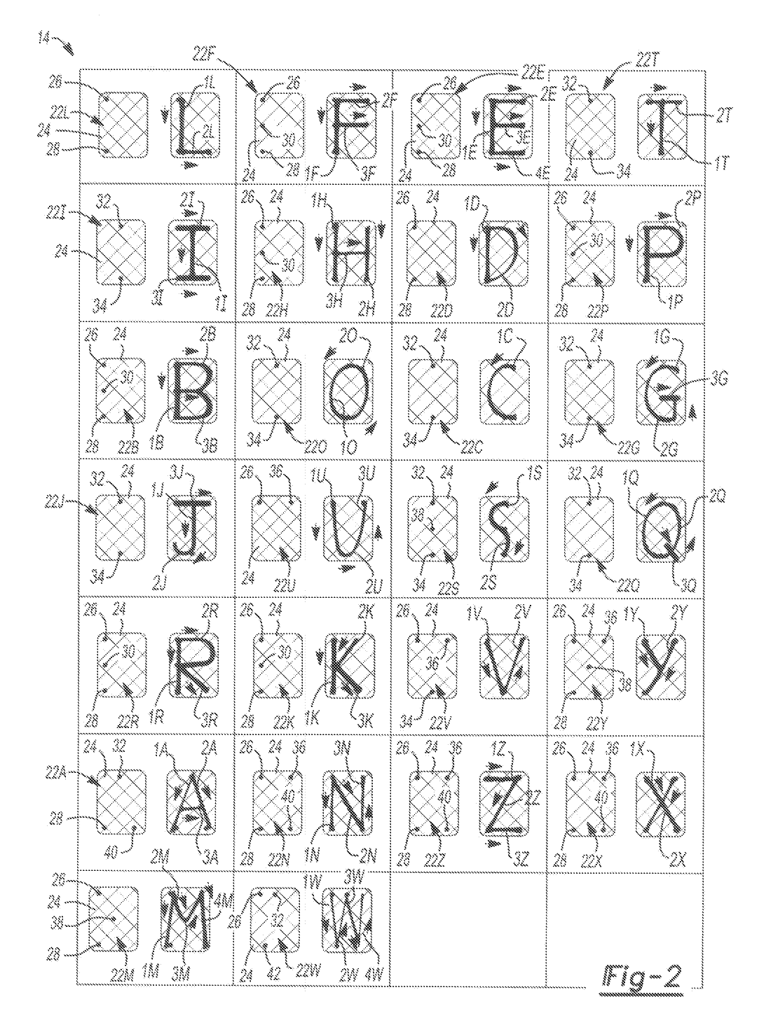

With additional reference to FIG. 2, each of the capital letters 14 are shown on letter templates generally specific to that letter. Each of the capital letters 14 can be formed using one or more letter formation strokes. These letter formation strokes are described in greater detail below with reference to each of the capital letters 14. In FIG. 2, the capital letters 14 are in an order that groups letters with similar letter formation strokes and are in an order that generally increases with technical handwriting difficulty. Specifically, it has been found that students' coordination with regard to drawing and handwriting generally develops in a specific order. This development generally starts with drawing vertical and horizontal lines, then proceeds to curved shapes, then proceeds to diagonal lines. In the example provided in FIG. 2, the capital letters 14 are in the order of L-F-E-T-I-H-D-P-B-O-C-G-J-U-S-Q-R-K-V-Y-A-N-Z-X-M-W, which generally follows the developmental order of learning letters with vertical and horizontal lines first, followed by curved letters, and ending with letters having diagonal components. In one alternative order (not specifically shown), the capital letters 14 can be in the order of L-F-E-D-P-B-R-O-Q-C-G-H-T-I-J-U-S-N-M-K-A-V-W-Y-X-Z. While the preceding orders of the capital letters 14 are given as examples, it is understood that other orders can be used. Additionally, while the following orders of the formation strokes for each letter are given as examples, it is understood that other sequences of the formation strokes can be used.

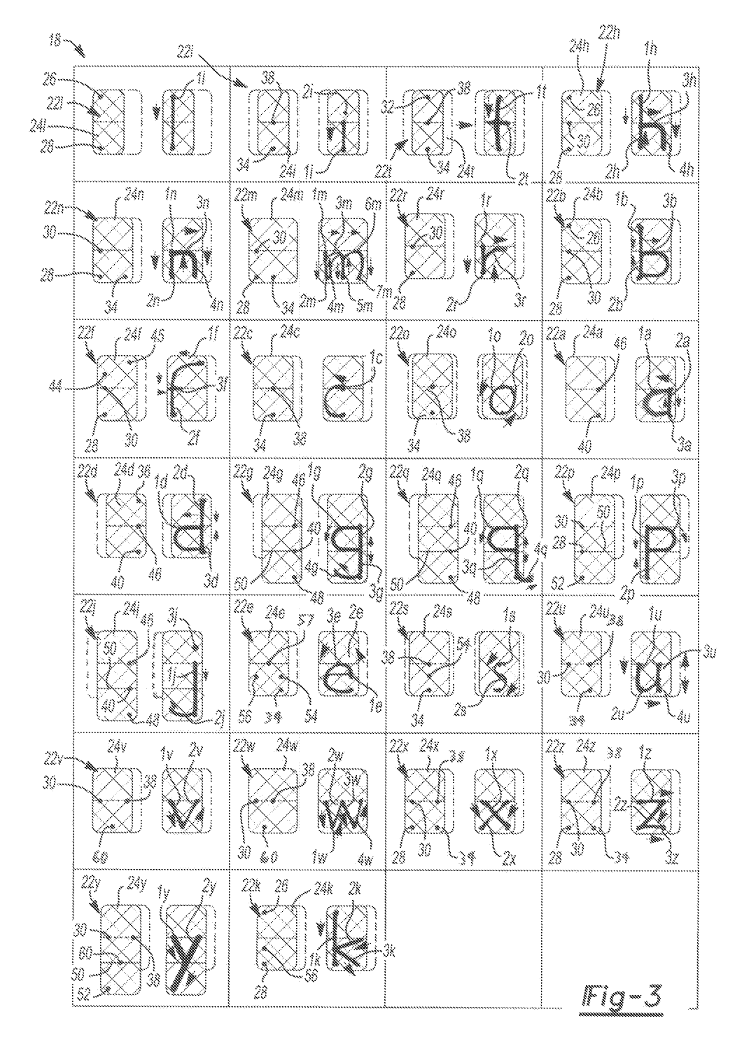

The letter L can be formed on an L template 22L that can include a rectangle 24, a first dot 26 and a second dot 28. The rectangle 24 can be oriented such that the longer sides of the rectangle 24 are located on the left and right of the rectangle 24 and the shorter sides are located on the top and bottom of the rectangle 24. The rectangle is of the size of the proper space (e.g. space on a page of paper or line of text) that the capital letter should take up so as to give a general visual cue or awareness of how large the letter should be and where to stop the letter formation strokes when dots do not specifically provide such cues. In the example provided, the rectangle 24 is lightly shaded without any borders, though other configurations can be used. In FIGS. 2 and 3, the light shading is represented by cross-hatching. It is understood that the cross-hatching is not actually to be shown as cross-hatching in the rectangle 24 and is only representative of the light shading that makes up or fills the rectangle 24. The light shading can be any color or degree of shading which allows the dots to be clearly visible, such as light grey for example.

The first dot 26 can be located in an upper left corner of the rectangle 24, and the second dot 28 can be located in a lower left corner of the rectangle 24. The letter L can be formed using two letter formation strokes. A first letter formation stroke 1L of the letter L can start at the first dot 26 and proceed in a straight, tall-line down motion to the second dot 28. A second letter formation stroke 2L can start at the second dot 28 and proceed to the right in a straight, line-across motion across the bottom of the rectangle 24.

The letter F can be formed on an F template 22F that can include the rectangle 24, the first dot 26, the second dot 28, and a third dot 30. The third dot 30 can be located at along the left side of the rectangle 24, linearly between the first and second dots 26, 28. In the example provided, the third dot 30 is located approximately halfway between the first and second dots 26, 28. The letter F can be formed using three letter formation strokes. A first letter formation stroke 1F of the letter F can start at the first dot 26 and proceed in a straight, tall-line down motion through the third dot 30 and to the second dot 28. A second letter formation stroke 2F can start at the first dot 26 and proceed to the right in a straight, line-across motion across the top of the rectangle 24. A third letter formation stroke 3F can start at the third dot 30 and proceed to the right in a straight, line-across motion across the middle of the rectangle 24. In the example provided, the second and third letter formation strokes 2F, 3F have the same length, though other configurations can be used.

The letter E can be formed on an E template 22E that can include the rectangle 24, the first dot 26, the second dot 28, and the third dot 30. The letter E can be formed using four letter formation strokes. A first letter formation stroke 1E of the letter E can start at the first dot 26 and proceed in a straight, tall-line down motion through the third dot 30 and to the second dot 28. A second letter formation stroke 2E can start at the first dot 26 and proceed to the right in a straight, line-across motion across the top of the rectangle 24. A third letter formation stroke 3E can start at the third dot 30 and proceed to the right in a straight, line-across motion across the middle of the rectangle 24. A fourth letter formation stroke 4E can start at the second dot 28 and proceed to the right in a straight, line-across motion across the bottom of the rectangle 24. In the example provided, the second, third, and fourth letter formation strokes 2E, 3E, 4E have the same length, though other configurations can be used.

The letter T can be formed on a T template 22T that can include the rectangle 24, and two dots: a fourth dot 32, and a fifth dot 34. The letter T can be formed using two letter formation strokes. A first letter formation stroke 1T of the letter T can start at the fourth dot 32 and proceed in a straight, tall-line down motion to the fifth dot 34. A second letter formation stroke 2T can start at an upper left corner of the rectangle 24 and proceed to the right in a straight, line-across motion across the top of the rectangle 24, through the fourth dot 32, and to the upper right corner of the rectangle 24.

The letter I can be formed on an I template 22I that can include the rectangle 24, the fourth dot 32, and the fifth dot 34. The letter I can be formed using three letter formation strokes. A first letter formation stroke 1I of the letter I can start at the fourth dot 32 and proceed in a straight, tall-line down motion to the fifth dot 34. A second letter formation stroke 2I can start at an upper left corner of the rectangle 24 and proceed to the right in a straight, line-across motion across the top of the rectangle 24, through the fourth dot 32, and to the upper right corner of the rectangle 24. A third letter formation stroke 3I can start at the lower left corner of the rectangle 24 and proceed to the right in a straight, line-across motion across the bottom of the rectangle 24, through the fifth dot 34, and to a lower right corner of the rectangle 24. It is understood that other fonts may omit the first and third letter formation strokes 1I, 3I of the letter I.

The letter H can be formed on an H template 22H that can include the rectangle 24, the first dot 26, the second dot 28, and the third dot 30. The letter H can be formed using three letter formation strokes. A first letter formation stroke 1H of the letter H can start at the first dot 26 and proceed in a straight, tall-line down motion through the third dot 30 and to the second dot 28. A second letter formation stroke 2H can start at the upper right corner of the rectangle 24 and proceed in a straight, tall-line down motion to the lower right corner of the rectangle 24. A third letter formation stroke 3H can start at the third dot 30 and proceed to the right in a straight, line-across motion across the middle of the rectangle 24, to the right side of the rectangle 24.

The letter D can be formed on a D template 22D that can include the rectangle 24, the first dot 26, and the second dot 28. The letter D can be formed using two letter formation strokes. A first letter formation stroke 1D of the letter D can start at the first dot 26 and proceed in a straight, tall-line down motion to the second dot 28. A second letter formation stroke 2D can start at the first dot 26 and proceed in a tall-curve down motion that curves in an arc toward the right and back to the left to end at the second dot 28.

The letter P can be formed on a P template 22P that can include the rectangle 24, the first dot 26, the second dot 28, and the third dot 30. The letter P can be formed using two letter formation strokes. A first letter formation stroke 1P of the letter P can start at the first dot 26 and proceed in a straight, tall-line down motion through the third dot 30 and to the second dot 28. A second letter formation stroke 2P can start at the first dot 26 and proceed in a short-curve down motion that curves in an arc toward the right and back to the left to end at the third dot 30.

The letter B can be formed on a B template 22B that can include the rectangle 24, the first dot 26, the second dot 28, and the third dot 30. The letter B can be formed using three letter formation strokes. A first letter formation stroke 1B of the letter B can start at the first dot 26 and proceed in a straight, tall-line down motion through the third dot 30 and to the second dot 28. A second letter formation stroke 2B can start at the first dot 26 and proceed in a short-curve down motion that curves in an arc toward the right and back to the left to end at the third dot 30. A third letter formation stroke 3B can start at the third dot 30 and proceed in a short-curve down motion that curves in an arc toward the right and back to the left to end at the second dot 28.

The letter O can be formed on an O template 22O that can include the rectangle 24, the fourth dot 32, and the fifth dot 34. The letter O can be formed using two letter formation strokes. A first letter formation stroke 1O of the letter O can start at the fourth dot 32 and can proceed in a tall-curve down motion that curves in an arc toward the left and back to the right to end at the fifth dot 34. A second letter formation stroke 2O can start at the fifth dot 34 and proceed in a tall-curve up motion that curves in an arc toward the right and back to the left to end at the fourth dot 32.

The letter C can be formed on a C template 22C that can include the rectangle 24, the fourth dot 32, and the fifth dot 34. The letter C can be formed using one letter formation stroke. A first letter formation stroke 1C of the letter C can start at the fourth dot 32 and can proceed in a tall-curve down motion that curves in an arc toward the left and back to the right to end at the fifth dot 34.

The letter G can be formed on a G template 22G that can include the rectangle 24, the fourth dot 32, and the fifth dot 34. The letter G can be formed using three letter formation strokes. A first letter formation stroke 1G of the letter G can start at the fourth dot 32 and can proceed in a tall-curve down motion that curves in an arc toward the left and back to the right to end at the fifth dot 34. A second letter formation stroke 2G can start at the fifth dot 34 and proceed in a short-line up motion that can end at the middle of the rectangle 24. A third letter formation stroke 3G can start horizontally between the end of the second letter formation stroke 2G (i.e. the middle of the rectangle 24) and the first letter formation stroke 1G and can proceed in a straight, line-across motion horizontally to the right side of the rectangle 24, intersecting with the end of the second letter formation stroke 2G.

The letter J can be formed on a J template 22J that can include the rectangle 24, the fourth dot 32, and the fifth dot 34. The letter J can be formed using three letter formation strokes. A first letter formation stroke 1J of the letter J can start at the fourth dot 32 and proceed in a straight, tall-line down motion to end at the fifth dot 34. A second letter formation stroke 2J can start at the fifth dot 34 and proceed in a bottom curve motion that curves upward in an arc to the left and ends before the middle of the rectangle 24. A third letter formation stroke 3J can start at an upper left corner of the rectangle 24 and proceed to the right in a straight, line-across motion across the top of the rectangle 24, through the fourth dot 32, and to the upper right corner of the rectangle 24. It is understood that other fonts may omit the third letter formation stroke 3J of the letter J

The letter U can be formed on a U template 22U that can include the rectangle 24, the first dot 26, and a sixth dot 36. The sixth dot 36 can be located in an upper right corner of the rectangle 24. The letter U can be formed using three letter formation strokes. A first letter formation stroke 1U of the letter U can start at the first dot 26 and proceed in a straight, tall-line down motion down the left side of the rectangle 24, but ending before the bottom left corner of the rectangle 24. A second letter formation stroke 2U can start at the end of the first letter formation stroke 1U and proceed in a bottom curve motion that curves upward in an arc to the right and ends before the middle of the rectangle 24. A third letter formation stroke 3U can start at the end of the second letter formation stroke 2U and proceed in a straight, tall-line up motion up the right side of the rectangle 24 to end at the sixth dot 36.

The letter S can be formed on an S template 22S that can include the rectangle 24, the fourth dot 32, the fifth dot 34, and a seventh dot 38. The seventh dot 38 can be located in the center of the rectangle 24. The letter S can be formed using two letter formation strokes. A first letter formation stroke 1S of the letter S can start at the fourth dot 32 and proceed in a short-curve down motion that curves in an arc toward the left and back to the right to end at the seventh dot 38. A second letter formation stroke 2S can start at the seventh dot 38 and proceed in a short-curve down motion that curves in an arc toward the right and back to the left to end at the fifth dot 34.

The letter Q can be formed on a Q template 22Q that can include the rectangle 24, the fourth dot 32 and the fifth dot 34. The letter Q can be formed using three letter formation strokes. A first letter formation stroke 1Q of the letter Q can start at the fourth dot 32 and can proceed in a tall-curve down motion that curves in an arc toward the left and back to the right to end at the fifth dot 34. A second letter formation stroke 2Q can start at the fifth dot 34 and proceed in a tall-curve up motion that curves in an arc toward the right and back to the left to end at the fourth dot 32. A third letter formation stroke 3Q can start proximate to the center of the rectangle 24 and proceed in a straight, small-diagonal motion down and toward the bottom right corner of the rectangle 24, such that the third letter formation stroke 3Q crosses the second letter formation stroke 2Q. The third letter formation stroke 3Q can end outside of the rectangle 24.

The letter R can be formed on an R template 22R that can include the rectangle 24, the first dot 26, the second dot 28, and the third dot 30. The letter R can be formed using three letter formation strokes. A first letter formation stroke 1R can start at the first dot 26 and proceed in a straight, tall-line down motion through the third dot 30 and to the second dot 28. A second letter formation stroke 2R can start at the first dot 26 and proceed in a short-curve down motion that curves in an arc toward the right and back to the left to end at the third dot 30. A third letter formation stroke 3R can start at the third dot 30 and proceed in a straight, short-diagonal down motion to end at the lower right corner of the rectangle 24.

The letter K can be formed on a K template 22K that can include the rectangle 24, the first dot 26, the second dot 28, and the third dot 30. The letter K can be formed using three letter formation strokes. A first letter formation stroke 1K of the letter K can start at the first dot 26 and proceed in a straight, tall-line down motion through the third dot 30 and to the second dot 28. A second letter formation stroke 2K can start at the top right corner of the rectangle 24 and proceed in a straight, short-diagonal down motion to the third dot 30. A third letter formation stroke 3K can start at the third dot 30 and proceed in a straight, short-diagonal down motion to the bottom right corner of the rectangle 24.

The letter V can be formed on a V template 22V that can include the rectangle 24, the first dot 26, the fifth dot 34, and the sixth dot 36. The letter V can be formed using two letter formation strokes. A first letter formation stroke 1V of the letter V can start at the first dot 26 and proceed in a straight, tall-diagonal down motion to the fifth dot 34. A second letter formation stroke 2V can start at the fifth dot 34 and proceed in a straight, tall-diagonal up motion to the sixth dot 36.

The letter Y can be formed on a Y template 22Y that can include the rectangle 24, the first dot 26, the second dot 28, the sixth dot 36, and the seventh dot 38. the letter Y can be formed using two letter formation strokes. A first letter formation stroke 1Y of the letter Y can start at the first dot 26 and proceed in a straight, short-diagonal down motion to the seventh dot 38. A second letter formation stroke 2Y can start at the sixth dot 36 and proceed in a straight, tall-diagonal down motion through the seventh dot 38 and to the second dot 28.

The letter A can be formed on an A template 22A that can include the rectangle 24, the second dot 28, the fourth dot 32, and an eighth dot 40. The eighth dot 40 can be located in the bottom right corner of the rectangle 24. The letter A can be formed using three letter formation strokes. A first letter formation stroke 1A of the letter A can start at the fourth dot 32 and proceed in a straight, tall-diagonal down motion to the second dot 28. A second letter formation stroke 2A can start at the fourth dot 32 and proceed in a straight, tall-diagonal down motion to the eighth dot 40. A third letter formation stroke 3A can start in the middle of the first letter formation stroke 1A and proceed to the right in a straight, line-across motion in the middle of the rectangle 24 and end at the middle of the second letter formation stroke 2A.

The letter N can be formed on an N template 22N that can include the rectangle 24, the first dot 26, the second dot 28, the sixth dot 36, and the eighth dot 40. The letter N can be formed using three letter formation strokes. A first letter formation stroke 1N of the letter N can start at the first dot 26 and proceed in a straight, tall-line down motion along the left side of the rectangle 24 to the second dot 28. A second letter formation stroke 2N can start at the first dot 26 and proceed in a straight, tall-diagonal down motion across the center of the rectangle 24 to the eighth dot 40. A third letter formation stroke 3N can start at the eighth dot 40 and proceed in a straight, tall-line up motion along the right side of the rectangle 24 to the sixth dot 36.

The letter Z can be formed on a Z template 22Z that can include the rectangle 24, the first dot 26, the second dot 28, the sixth dot 36, and the eighth dot 40. The letter Z can be formed using three letter formation strokes. A first letter formation stroke 1Z of the letter Z can start at the first dot 26 and proceed to the right in a straight, line-across motion across the top of the rectangle 24 to the sixth dot 36. A second letter formational stroke 2Z can start at the sixth dot 36 and proceed in a straight, tall-diagonal down motion across the center of the rectangle 24 to the second dot 28. A third letter formation stroke 3Z can start at the second dot 28 and proceed to the right in a straight, line across motion across the bottom of the rectangle 24 to the eighth dot 40.

The letter X can be formed on an X template 22X that can include the rectangle 24, the first dot 26, the second dot 28, the sixth dot 36, and the eighth dot 40. The letter X can be formed using two letter formation strokes. A first letter formation stroke 1X of the letter X can start at the first dot 26 and proceed in a straight, tall-diagonal down motion across the center of the rectangle 24 to the eighth dot 40. A second letter formation stroke 2X can start at the sixth dot 36 and proceed in a straight, tall-diagonal down motion across the center of the rectangle 24 to the second dot 28.

The letter M can be formed on an M template 22M that can include the rectangle 24, the first dot 26, the second dot 28, and the seventh dot 38. The letter M can be formed using four letter formation strokes. A first letter formation stroke 1M of the letter M can start at the first dot 26 and proceed in a straight, tall-line down motion down the left side of the rectangle 24 to the second dot 28. A second letter formation stroke 2M can start at the first dot 26 and proceed in a straight, short-diagonal down motion to the seventh dot 38. A third letter formation stroke 3M can start at the seventh dot 38 and proceed in a straight, short-diagonal up motion to the top right corner of the rectangle 24. A fourth letter formation stroke 4M can start at the end of the third letter formation stroke 3M (i.e. the top right corner of the rectangle 24) and proceed in a straight, tall-line down motion down the right side of the rectangle 24 to the bottom right corner of the rectangle 24. Alternatively, the seventh dot 38 can be replaced with the fifth dot 34 and the second and third letter formation strokes 2M and 3M can be straight, tall-diagonal down and straight, tall-diagonal up motions, respectively.

The letter W can be formed on a W template 22W that can include the rectangle 24, the first dot 26, the fourth dot 32, and a ninth dot 42. The ninth dot 42 can be located vertically along the bottom side of the rectangle 24 and horizontally equidistant from the first dot 26 and the fourth dot 32. The letter W can be formed using four letter formation strokes. A first letter formation stroke 1W of the letter W can start at the first dot 26 and proceed in a straight, tall-diagonal down motion to the ninth dot 42. A second letter formation stroke 2W can start at the ninth dot 42 and proceed in a straight, tall-diagonal up motion to the fourth dot 32. A third letter formation stroke 3W can start at the fourth dot 32 and proceed in a straight, tall-diagonal down motion to end at the bottom side of the rectangle 24 and horizontally equidistant from the fourth dot 32 and the top right corner of the rectangle 24. A fourth letter formation stroke 4W can start at the end of the third letter formation stroke 3W and proceed to the top right corner of the rectangle 24.

With additional reference to FIG. 3, each of the lower case letters 18 are shown on letter templates specific to that letter. Each of the lower case letters 18 can be formed using one or more letter formation strokes. These letter formation strokes described in greater detail below with reference to each of the lower case letters 18. In FIG. 3, the lower case letters 18 are in an order that groups letters with similar letter formation strokes and are in an order that generally increases with technical handwriting difficulty. In the example provided in FIG. 3, the lower case letters 18 are in the order of l-i-t-h-n-m-r-b-f-c-o-a-d-g-q-p-j-e-s-u-v-w-x-z-y-k. In one alternative order, the lower case letters 18 can be in the order l-i-t-h-n-m-r-b-f-c-o-a-d-g-q-p-j-e-s-u-v-w-x-z-y-k. While the preceding orders of the lower case letters 18 are given as examples, it is understood that other orders can be used. Additionally, while the following orders of the formation strokes for each letter are given as examples, it is understood that other sequences of the formation strokes can be used.

The letter I can be formed on an I template 22I that can include a rectangle 24I, the first dot 26 and the second dot 28. The rectangle 24I can be similar to the rectangle 24 used with the capital letters 14 in FIG. 2, except as shown and described herein. More specifically, since the proper space needed for the letter I is less than that of the rectangle 24, the rectangle 24I can be narrower than rectangle 24. The full size of rectangle 24 relative to rectangle 24I is shown in dashed lines. The rectangle 24I can also include a light dotted line that spans the entire rectangle 24I horizontally across the center of the rectangle 24I. The horizontal light dotted line provides a visual cue as to the middle of the rectangle 24I. The letter I can be formed using one letter formation stroke. A first letter formation stroke 1I of the letter I can start at the first dot 26 and proceed in a straight, tall-line down motion to the second dot 28.

The letter i can be formed on an i template 22i that can include a rectangle 24i, the seventh dot 38, and the fifth dot 34. The rectangle 24i can be similar to the rectangle 24I except as shown and described herein. More specifically, the rectangle 24i can be centered around the seventh dot 38. The full size of rectangle 24 relative to rectangle 24i is shown in dashed lines. The letter i can be formed using two letter formation strokes. A first letter formation stroke 1i of the letter i can start at the seventh dot 38 and proceed in a straight, short-line down motion to the fifth dot 34. A second letter formation stroke 2i can be a dot or point located directly above the first letter formation stroke 1i and between the top of the rectangle 24i and the seventh dot 38.

The letter t can be formed on a t template 22t that can include a rectangle 24t, the fourth dot 32, the fifth dot 34, and the seventh dot 38. The rectangle 24t can be similar to the rectangle 24i. The letter t can be formed using two letter formation strokes. A first letter formation stroke 1t of the letter t can start at the fourth dot 32 and proceed in a straight, tall-line down motion to the fifth dot 34. A second letter formation stroke 2t can start on the left side of the rectangle 24t, vertically aligned with the seventh dot 38, and proceed right in a straight, line-across motion near the top, that passes through the seventh dot 38 and to the right side of the rectangle 24t.

The letter h can be formed on an h template 22h that can include a rectangle 24h, the first dot 26, the second dot 28, and the third dot 30. The rectangle 24h can be similar to the rectangle 24 used with the capital letters 14 in FIG. 2, except as shown and described herein. More specifically, since the proper space needed for the letter h is less than that of the rectangle 24 and greater than that of rectangle 24I, the rectangle 24h can be narrower than rectangle 24, but wider than rectangle 24I. The full size of rectangle 24 relative to rectangle 24h is shown in dashed lines. The rectangle 24h can also include the light dotted line that spans the entire rectangle 24h horizontally across the center of the rectangle 24I. The letter h can be formed using four letter formation strokes. A first letter formation stroke 1h of the letter h can start at the first dot 26 and proceed in a straight, tall-line down motion through the third dot 30 and to the second dot 28. A second letter formation stroke 2h can start at the second dot 28 and proceed in a straight, short-line up motion to the third dot 30. A third letter formation stroke 3h can start at the third dot 30 and proceed in a top-curve motion at the middle of the rectangle 24h that arcs up and then back down. A fourth letter formation stroke 4h can start at the end of the third letter formation stroke 3h and proceed in a straight, short-line down motion to the bottom right corner of the rectangle 24h.

The letter n can be formed on an n template 22n that can include a rectangle 24n, the second dot 28, the third dot 30, and the fifth dot 34. The rectangle 24n can be similar to the rectangle 24h. The letter n can be formed using four letter formation strokes. A first letter formation stroke 1n can start at the third dot 30 and proceed in a straight, short-line down motion to the second dot 28. A second letter formation stroke 2n can start at the second dot 28 and proceed in a straight, short-line up motion and end just below the third dot 30. A third letter formation stroke 3n can start at the end of the second letter formation stroke 2n and proceed in a top-curve motion at the middle of the rectangle 24n that arcs up and then back down. A fourth letter formation stroke 4n can start at the end of the third letter formation stroke 3n and proceed in a straight, short-line down motion to the lower right corner of the rectangle 24n to end at the fifth dot 34.

The letter m can be formed on an m template 22m that can include a rectangle 24m, the second dot 28, the third dot 30, and the fifth dot 34. The rectangle 24m can be similar to the rectangle 24, except as shown and described herein. In the example provided, the rectangle 24m can take up the same space as the rectangle 24 but can include the horizontal dotted line across the middle of the rectangle 24m. The letter m can be formed in seven letter formation strokes. A first letter formation stroke 1m of the letter m can start at the third dot 30 and proceed in a straight, short-line down motion to the second dot 28. A second letter formation stroke 2m can start at the second dot 28 and proceed in a straight, short-line up motion and end just below the third dot 30. A third letter formation stroke 3m can start at the end of the second letter formation stroke 2m and proceed in a top-curve motion at the middle of the rectangle 24m that arcs up and then back down to the right to end at the center of the rectangle 24m. A fourth letter formation stroke 4m can start at the end of the third letter formation stroke 3m and proceed in a straight, short-line down motion to the fifth dot 34. A fifth letter formation stroke 5m can start at the fifth dot 34 and proceed in a straight, short-line up motion and end vertically just below the third dot 30 (i.e. at the end of the third letter formation stroke 3m. A sixth letter formation stroke 6m can start at the end of the fifth letter formation stroke 5m and proceed in a top-curve motion at the middle of the rectangle 24m that arcs up and then back down to the right at the right side of the rectangle 24m. A seventh letter formation stroke 7m can start at the end of the sixth letter formation stroke 6m and proceed in a straight, short-line down motion along the right side to the bottom right corner of the rectangle 24m.

The letter r can be formed on an r template 22r that can include a rectangle 24r, the second dot 28, and the third dot 30. The rectangle 24r can be similar to the rectangle 24h. The letter r can be formed using three letter formation strokes. A first letter formation stroke 1r of the letter r can begin at the third dot 30 and proceed in a straight, line-down motion to the second dot 28. A second letter formation stroke 2r can begin at the second dot 28 and proceed in a straight, short-line up motion and end just below the third dot 30. A third letter formation stroke 3r can start at the end of the second letter formation stroke 2r and proceed in a top-curve motion at the middle of the rectangle 24r that arcs up and then back down to the right to end at the center of the rectangle 24r.

The letter b can be formed on a b template 22b that can include a rectangle 24b, the first dot 26, the second dot 28, and the third dot 30. The rectangle 24b can be similar to the rectangle 24h. The letter b can be formed using three letter formation strokes. A first letter formation stroke 1b can start at the first dot 26 and proceed in a straight, tall-line down motion to the second dot 28. A second letter formation stroke 2b can start at the second dot 28 and proceed in a straight, short-line up motion to end just below the third dot 30. A third letter formation stroke 3b can start at the end of the second letter formation stroke 2b and proceed in a short-curve down motion that curves in an arc toward the right and back to the left to end at the second dot 28.

The letter f can be formed on an f template 22f that can include a rectangle 24f, the second dot 28, the third dot 30, a tenth dot 44, and an eleventh dot 45. The rectangle 24f can be similar to the rectangle 24h. The tenth dot 44 can be located horizontally in line with the second and third dots 28, 30, and can be vertically approximately half-way between the third dot 30 and the top of the rectangle 24f. The eleventh dot 45 can be located in the upper right corner of the rectangle 24f. The letter f can be formed using three letter formation strokes. A first letter formation stroke 1f of the letter f can start at the eleventh dot 45 and proceed in a top-curve motion at the top of the rectangle 24f that proceeds in a straight line to the left, then curves downward to the tenth dot 44. A second letter formation stroke 2f can start at the tenth dot 44 and proceed in a straight, tall-line down motion to the second dot 28. A third letter formation stroke 3f can start left of the third dot 30 and proceed in a straight, line-across motion across near the top, that proceeds toward the right of the rectangle 24f, passing through the third dot 30 and ending slightly to the right of the third dot 30.

The letter c can be formed on a c template 22c that can include a rectangle 24c, the fifth dot 34, and the seventh dot 38. The rectangle 24c can be similar to the rectangle 24h. The letter c can be formed using one letter formation stroke. A first letter formation stroke 1c of the letter c can start at the seventh dot 38 and proceed in a short-curve down motion that arcs to the left and back to the right to the fifth dot 34.

The letter o can be formed on an o template 22o that can include a rectangle 24o, the fifth dot 34, and the seventh dot 38. The rectangle 24o can be similar to the rectangle 24h except as shown and described herein. More specifically, the rectangle 24o can be centered about the seventh dot 38. The letter o can be formed using two letter formation strokes. A first letter formation stroke 1o of the letter o can start at the seventh dot 38 and proceed in a short-curve down motion that arcs to the left and back to the right to the fifth dot 34. A second letter formation stroke 2o can start at the fifth dot 34 and proceed in a short-curve up motion that arcs to the right and back to the left to the seventh dot 38.

The letter a can be formed on an a template 22a that can include a rectangle 24a, the eighth dot 40, and twelfth dot 46. The rectangle 24a can be similar to the rectangle 24h except as shown and described herein. More specifically, the rectangle 24a can be positioned such that the eighth dot 40 is located in the lower right corner of the rectangle 24a. The twelfth dot 46 can be located at the middle of the right side of the rectangle 24a, above the eighth dot 40. The letter a can be formed using three letter formation strokes. A first letter formation stroke 1a of the letter a can start at the twelfth dot 46 and proceed in a short-curve down motion that arcs to the left and back to the right to end at the eighth dot 40. A second letter formation stroke 2a can start at the eighth dot 40 and proceed in a straight, short-line up motion to the twelfth dot 46. A third letter formation stroke 3a can start at the twelfth dot 46 and proceed in a straight, short-line down motion to the eighth dot 40.

The letter d can be formed on a d template 22d that can include a rectangle 24d, the sixth dot 36, the eighth dot 40, and the twelfth dot 46. The rectangle 24d can be similar to the rectangle 24a. A first letter formation stroke 1d of the letter d can start at the sixth dot 36 and proceed in a straight, tall-line down motion to the eighth dot 40. A second letter formation stroke 2d can start at the eighth dot 40 and proceed in a straight, short-line up motion to the twelfth dot 46. A third letter formation stroke 3d can start at the twelfth dot 46 and proceed in a short-curve down motion that arcs to the left and back to the right to the eighth dot 40.

The letter g can be formed on a g template 22g that can include a rectangle 24g, the eighth dot 40, the twelfth dot 46, a thirteenth dot 48, and a line 50. The rectangle 24g can be similar to the rectangle 24d except as shown and described herein. More specifically, the rectangle 24g can extend below the rectangle 24d. The thirteenth dot 48 can be located horizontally in line with the eighth dot 40 and the twelfth dot 46 and vertically between the eighth dot 40 and the bottom of the rectangle 24g. The line 50 can be a solid horizontal line that passes through the eighth dot 40 and extends across the whole rectangle 24g. The letter g can be formed using four letter formation strokes. A first letter formation stroke 1g of the letter g can start at the twelfth dot 46 and proceed in a short-curve down motion that arcs to the left and back to the right to the eighth dot 40. A second letter formation stroke 2g can start at the eighth dot 40 and proceed in a straight, line-up motion to the twelfth dot 46. A third letter formation stroke 3g can start at the twelfth dot 46 and proceed in a straight, tall-line down motion below the line 50 and to the thirteenth dot 48. A fourth letter formation stroke 4g can start at the thirteenth dot 48 and proceed in a low bottom-curve motion that arcs down toward the left and back up to end below the line 50.

The letter q can be formed on a q template 22q that can include a rectangle 24q, the eighth dot 40, the twelfth dot 46, the thirteenth dot 48, and the line 50. The rectangle 24q can be similar to the rectangle 24g. The letter q can be formed using four letter formation strokes. A first letter formation stroke 1q of the letter q can start at the twelfth dot 46 and proceed in a short-curve down motion that arcs to the left and back to the right to the eighth dot 40. A second letter formation stroke 2q can start at the eighth dot 40 and proceed in a straight, line-up motion to the twelfth dot 46. A third letter formation stroke 3q can start at the twelfth dot 46 and proceed in a straight, tall-line down motion to end below the line 50 at the thirteenth dot 48. A fourth letter formation stroke 4q can start at the eighth dot 40 and proceed in a bottom-curve motion that arcs down and back up to the right to end below the line 50.

The letter p can be formed on a p template 22p that can include a rectangle 24p, the second dot 28, the third dot 30, a fourteenth dot 52, and the line 50. The rectangle 24p can be similar to the rectangle 24g except as shown and described herein. More specifically, the rectangle 24g can be horizontally positioned such that the second and third dots 28, 30 are positioned along the left side of the rectangle 24p. The fourteenth dot 52 can be located horizontally in line with the second dot 28 and the third dot 30 and vertically between the second dot 28 and the bottom of the rectangle 24p. The letter p can be formed using three letter formation strokes. A first letter formation stroke 1p of the letter p can start at the third dot 30 and proceed in a straight, tall-line down below the line 50 motion to end at the fourteenth dot 52. A second letter formation stroke 2p can start at the fourteenth dot 52 and proceed in a straight, tall-line up motion to the third dot 30. A third letter formation stroke 3p can start at the third dot 30 and proceed in a short-curve down motion that arcs to the right and back to the left to end at the second dot 28.

The letter j can be formed on a j template 22j that can include a rectangle 24j, the eighth dot 40, the twelfth dot 46, the thirteenth dot 48, and the line 50. The rectangle 24j can be similar to the rectangle 24g. The letter j can be formed using three letter formation strokes. A first letter formation stroke 1j of the letter j can start at the twelfth dot 46 and proceed in a straight, tall-line down motion below the line 50, through the eighth dot 40 and to the thirteenth dot 48. A second letter formation stroke 2j can start at the thirteenth dot 48 and proceed in a bottom-curve motion that arcs toward the left, down and back up, remaining below the line 50. A third letter formation stroke 3j can be a dot or point formed horizontally in line with the first letter formation stroke 1j and vertically above the twelfth dot 46.

The letter e can be formed on an e template 22e that can include a rectangle 24e, the fifth dot 34, a fifteenth dot 54, a sixteenth dot 56, and a seventeenth dot 57. The rectangle 24e can be similar to the rectangle 24h. The fifteenth dot 54 can be located horizontally in-line with the fifth dot 34 and vertically approximately half-way between the fifth dot 34 and the center of the rectangle 24e. The sixteenth dot 56 can be located vertically in line with the fifteenth dot 54 and along the left side of the rectangle 24. The seventeenth dot 57 can be located in the center of the rectangle 24e. The letter e can be formed using three letter formation strokes. A first letter formation stroke 1e of the letter e can start at the sixteenth dot 56 and proceed in a straight, line-across motion to the right to end at the fifteenth dot 54. A second letter formation stroke 2e can start at the fifteenth dot 54 and proceed in a top-curve motion at the middle of the rectangle 24e that arcs up toward the left to the seventeenth dot 57. A third letter formation stroke 3e can start at the seventeenth dot 57 and proceed in a short-curve down motion that arcs down to the left, through the sixteenth dot 56, and back to the right to end at the fifth dot 34.

The letter s can be formed on an s template 22s that can include a rectangle 24s, the fifth dot 34, the seventh dot 38, and the fifteenth dot 54. The rectangle 24s can be similar to the rectangle 24o. The letter s can be formed using two letter formation strokes. A first letter formation stroke 1s of the letter s can start at the seventh dot 38 and proceed in a short-curve down motion that arcs down toward the left and back to the right to end at the fifteenth dot 54. A second letter formation stroke 2s can start at the fifteenth dot 54 and proceed in a short-curve down motion that arcs down and toward the right and back to the left to end at the fifth dot 34.

The letter u can be formed on a u template 22u that can include a rectangle 24u, the third dot 30, the fifth dot 34, and the seventh dot 38. The rectangle 24u can be similar to the rectangle 24h. The letter u can be formed using four letter formation strokes. A first letter formation stroke 1u of the letter u can start at the third dot 30 and proceed in a straight, short-line down motion to the bottom left corner of the rectangle 24u. A second letter formation stroke 2u can start at the end of the first letter formation stroke 1u (i.e. at the bottom left corner of the rectangle 24u) and proceed in a bottom-curve motion that curves down and to the right and back up to the fifth dot 34. A third letter formation stroke 3u can start at the fifth dot 34 and proceed in a straight, short-line up motion to the seventh dot 38. A fourth letter formation stroke 4u can start at the seventh dot 38 and proceed in a straight, short-line down motion to the bottom right of the rectangle 24u.

The letter v can be formed on a v template 22v that can include a rectangle 24v, the third dot 30, the seventh dot 38, and a nineteenth dot 60. The rectangle 24v can be similar to the rectangle 24h. The nineteenth dot 60 can be located vertically along the bottom of the rectangle 24v and horizontally half-way between the third and seventh dots 30, 38. The letter v can be formed using two letter formation strokes. A first letter formation stroke 1v of the letter v can start at the third dot 30 and proceed in a straight, short-diagonal down motion to the nineteenth dot 60. A second letter formation stroke 2v can start at the nineteenth dot 60 and proceed in a straight, short-diagonal up motion to the seventh dot 38.

The letter w can be formed on a w template 22w that can include a rectangle 24w, the third dot 30, the seventh dot 38, and the nineteenth dot 60. The rectangle 24w can be similar to the rectangle 24m. The letter w can be formed using four letter formation strokes. A first letter formation stroke 1w of the letter w can start at the third dot 30 and proceed in a straight, short-diagonal down motion to the nineteenth dot 60. A second letter formation stroke 2w can start at the nineteenth dot 60 and proceed in a straight, short-diagonal up motion to the seventh dot 38. A third letter formation stroke 3w can start at the seventh dot 38 and proceed in a straight, short-diagonal down motion to the bottom side of the rectangle 24w at a location that is horizontally half-way between the seventh dot 38 and the right side of the rectangle 24w. A fourth letter formation stroke 4w can start at the end of the third letter formation stroke 3w and proceed in a straight, diagonal-up motion to the right side of the rectangle 24w to a location that is vertically aligned with the third and seventh dots 30, 38.

The letter x can be formed on an x template 22x that can include a rectangle 24x, the second dot 28, the third dot 30, the fifth dot 34, and the seventh dot 38. The rectangle 24x can be similar to the rectangle 24h. The letter x can be formed using two letter formation strokes. A first letter formation stroke 1x of the letter x can start at the third dot 30 and proceed in a straight, diagonal-line down motion to the fifth dot 34. A second letter formation stroke 2x can start at the seventh dot 38 and proceed in a straight, diagonal-line down motion to the second dot 28.

The letter z can be formed on a z template 22z that can include a rectangle 24z, the second dot 28, the third dot 30, the fifth dot 34, and the seventh dot 38. The rectangle 24z can be similar to the rectangle 24h. The letter z can be formed using three letter formation strokes. A first letter formation stroke 1z of the letter z can start at the third dot 30 and proceed in a straight, line-across motion across the middle of the rectangle 24z to the seventh dot 38. A second letter formation stroke 2z can start at the seventh dot 38 and proceed in a straight, diagonal-down motion to the second dot 28. A third letter formation stroke 3z can start at the second dot 28 and proceed in a straight, line-across motion across the bottom of the rectangle 24z to the fifth dot 34.

The letter y can be formed on a y template 22y that can include a rectangle 24y, the third dot 30, the seventh dot 38, fourteenth dot 52, the nineteenth dot 60, and the line 50. The rectangle 24y can be similar to the rectangle 24p. The letter y can be formed using two letter formation strokes. A first letter formation stroke 1y of the letter y can start at the third dot 30 and proceed in a straight, short-diagonal down motion to the nineteenth dot 60. A second letter formation stroke 2y can start at the seventh dot 38 and proceed in a straight, tall-diagonal down motion, through the nineteenth dot 60, and below the line 50 to end at the fourteenth dot 52.

The letter k can be formed on a k template 22k that can include a rectangle 24k, the first dot 26, the second dot 28, and the sixteenth dot 56. The rectangle 24k can be similar to the rectangle 24h. The letter k can be formed using three letter formation strokes. A first letter formation stroke 1k of the letter k can start at the first dot 26 and proceed in a straight, tall-line down motion to the second dot 28. A second letter formation stroke 2k can start at the right side of the rectangle 24k at a location that is vertically aligned with the center of the rectangle 24k and proceed in a straight, short-diagonal down motion to the sixteenth dot 56. A third letter formation stroke 3k can start at the sixteenth dot 56 and proceed in a straight, short-diagonal down motion to the right side of the rectangle 24k to end at the bottom right corner of the rectangle 24k.

The letter formation strokes and their respective orders described above are examples and are not meant to limit the teachings to exclude minor deviations and/or re-ordering of the letters or letter formation strokes from those described above.

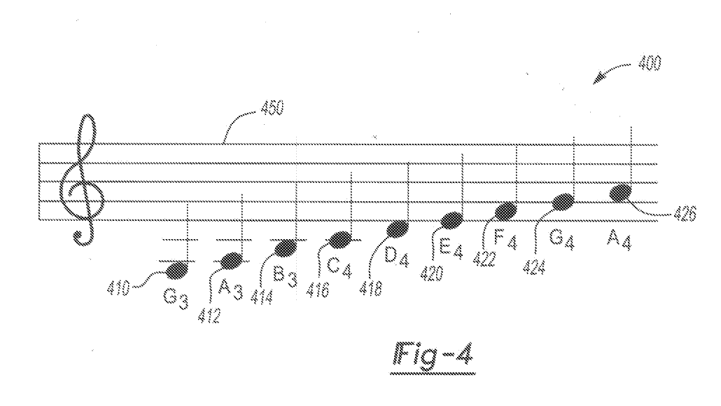

With additional reference to FIG. 4, an example of a musical notation 400 is shown including notes in ascending pitch order: G₃ 410, A₃ 412, B₃ 414, C₄ 416, D₄ 418, E₄ 420, F₄ 422, G₄ 424, and A₄ 426 on a staff 450. It is understood that additional notes can be used, such as additional notes (not specifically shown) having a higher pitch than the A₄ note 426 or a lower pitch than the A₃ note 412 for example. It is also understood that half-step notes can be used, such as sharps or flats for example. The notes are shown as quarter notes only for illustration purposes and it is understood that different time durations (e.g. eighth notes, half notes, whole notes, etc.) can be used.

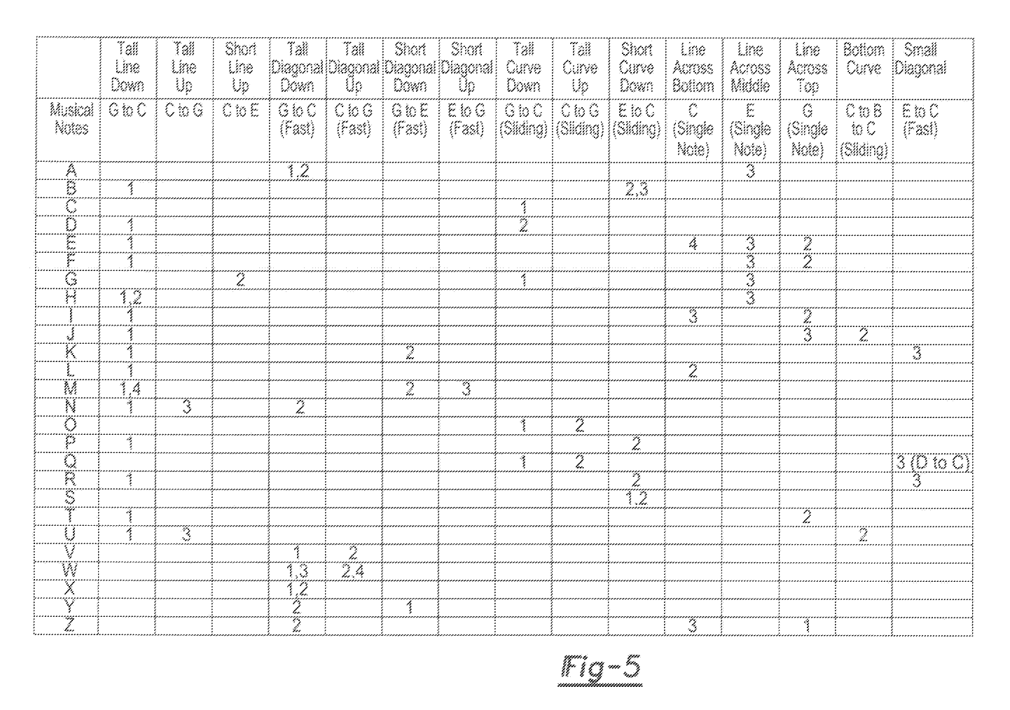

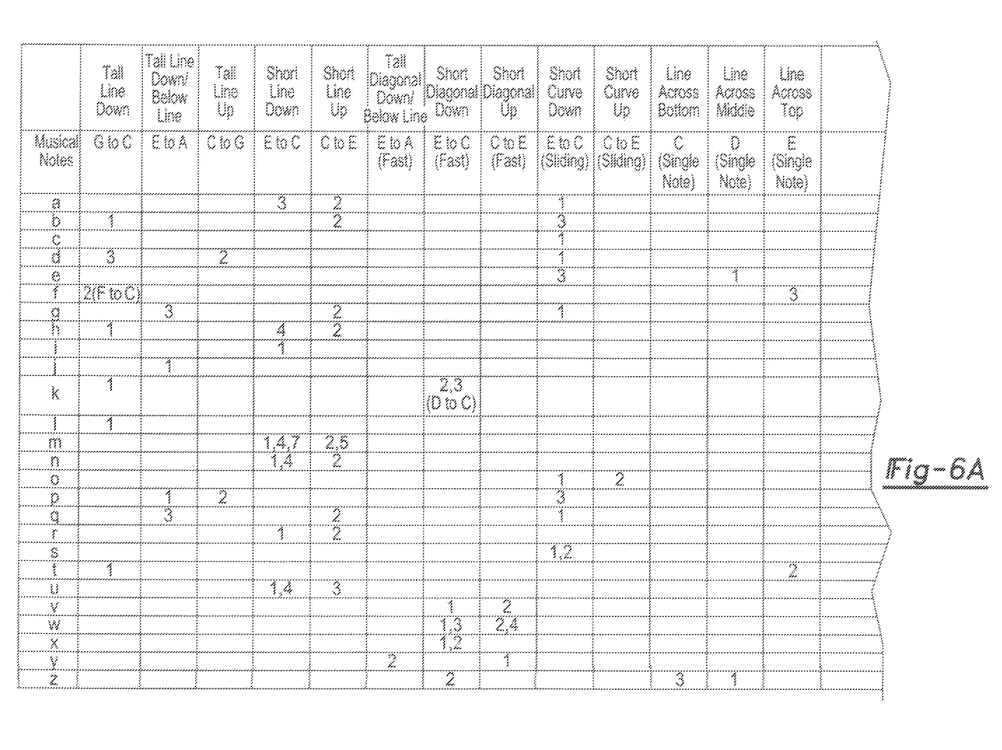

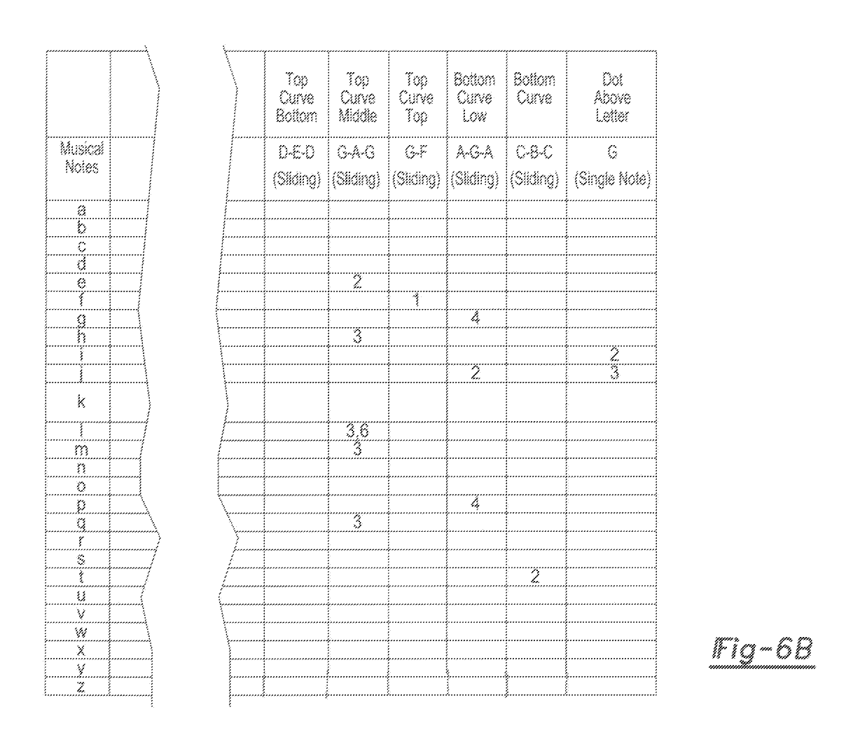

With additional reference to FIGS. 5, 6A and 6B, example pairings of musical notes to the letter formation strokes of the capital letters 14 and lower case letters 18, respectively discussed above with reference to FIGS. 2 and 3, are shown. Generally, vertical downward motions are paired with descending pitches, vertical upward motions are paired with ascending pitches, diagonal downward motions are paired with descending pitches that change more quickly than vertical downward motions, diagonal upward motions are paired with ascending pitches that change more quickly than vertical upward motions, curves are paired with sliding notes, and horizontal lines are paired with single notes.

In the example provided, tall-line down motions (e.g. 1B, 1D, 1E, 1F, 1H, 3H, 1I, 1J, 1K, 1L, 1M, 4M, 1N, 1P, 1R, 1T, 1U, 1b, 3d, 2f, 1h, 1k, 1l, 1t) are paired to a pitch change from G to C, though other descending pitch changes can be used. In the example provided, the note G₄ 424 is played, followed directly by the note C₄ 416 in the case of letter formation strokes 1L, 1T, 21, 1D, 1J, 1U, 1N, 1M, and 1I. In the example provided, letters that have subsequent letter formation strokes that start or end at locations in the middle of the tall-line down motion (e.g. the letters F, E, H, P, B, R, K, t, h, b, f, d, k) can include an intermediate note between the G₄ 424 and C₄ 416 notes. For example, the note G₄ 424 is played, followed directly by a note such as E₄ 420 to indicate an important middle position, followed directly by note C₄ 416.

In the example provided, tall-line down motions that go below the line 50 (e.g. 3g, 1j, 1p, 3q) are paired with a pitch change from E to A, though other descending pitch changes can be used. In the example provided, the note E₄ 420 is played, followed directly by an intermediate note such as C₄ 416, to indicate an important middle position, followed directly by note A₃ 412.

In the example provided, tall-line up motions (e.g. 3N, 3U, 2d, 2p) are paired to a pitch change from C to G, though other ascending pitch changes can be used. In the example provided, the note C₄ 416 is played, followed directly by the note G₄ 424.

In the example provided, short-line down motions (e.g. 3a, 4h, 1i, 1m, 4m, 7m, 1n, 4n, 1r, 1u, 4u) are paired with a pitch change from E to C, though other descending pitch changes can be used. In the example provided, the note E₄ 420 is played, followed directly by the note C₄ 416.

In the example provided, short-line up motions (e.g. 2G, 2a, 2b, 2g, 2h, 2m, 5m, 2n, 2q, 2r, 3u) are paired to a pitch change from C to E, though other ascending pitch changes can be used. In the example provided, the note C₄ 416 is played, followed directly by the note E₄ 420.

In the example provided, tall-diagonal down motions (e.g. 1A, 2A, 2N, 1V, 1W, 3W, 1X, 2X, 2Y, 2Z) are paired to a pitch change from G to C that is faster than the pitch change for tall-line down motions, though other descending pitch changes can be used. For example, the notes of the tall-line down motion may be whole notes, while the notes of the tall-diagonal down motions may be half or quarter notes. In the example provided, the note G₄ 424 is played, followed directly by the note C₄ 416.

In the example tall-diagonal down motions that go below the line 50 (e.g. 2y) are paired to a pitch change from E to A that is faster than the pitch change for tall-line down motions, though other descending pitch changes can be used. For example, the notes of the tall-line down motion may be whole notes, while the notes of the tall-diagonal down motions that go below the line 50 may be half or quarter notes. In the example provided, the note E₄ 420 is played, followed directly by the note A₃ 412.

In the example provided, tall-diagonal up motions (e.g. 2V, 2W, 4W) are paired to a pitch change from C to G that is faster than the pitch change for tall-line up motions, though other ascending pitch changes can be used. For example, the notes of the tall-line up motion may be whole notes, while the notes of the tall-diagonal up motions may be half or quarter notes. In the example provided, the note C₄ 416 is played, followed directly by the note G₄ 424 in the case of letter formation strokes 2V, 2W, and 4W.

In the example provided, short-diagonal down motions (e.g. 2K, 3K, 2M, 3R, 1Y, 2k, 3k, 1v, 1w, 3w, 1x, 2x, 1y, 2z) are paired to a pitch change from G to E, E to C, or from D to C that is faster than the pitch change for tall-line down motions, though other descending pitch changes can be used. For example, the notes of the tall-line down motion may be whole notes, while the notes of the short-diagonal down motions may be half or quarter notes. In the example provided, the note G₄ 424 is played, followed directly by the note E₄ 420 in the case of letter formation strokes 2K, 2M, and 1Y. In the example provided, the note E₄ 420 is played, followed directly by the note C₄ 416 in the case of letter formation strokes 3K, 3R, 1v, 1w, 3w, 1x, 2x, 1y, and 2z. In the example provided, the note D₄ 418 is played, followed directly by the note C₄ 416 in the case of letter formation strokes 3Q, 2k and 3k.

In the example provided, short-diagonal up motions (e.g. 3M, 2v, 2w, 4w) are paired to a pitch change from C to E or D to E that is faster than the pitch change for tall-line up motions, though other ascending pitch changes can be used. For example, the notes of the tall-line up motion may be whole notes, while the notes of the short-diagonal up motions may be half or quarter notes. In the example provided, the note C₄ 416 is played, followed directly by the note E₄ 420 in the case of letter formation strokes 3M, 2v, 2w, and 4w.

In the example provided, tall-curve down motions (e.g. 1C, 2D, 1G, 1O, 1Q) are paired to a sliding pitch change from G to C, though other descending pitch changes can be used. In the example provided, the note G₄ 424 is played and the notes from G₄ 424 to C₄ 416 are played in a sliding manner which is commonly indicated by a slide or glissando on musical notation for example.

In the example provided, tall-curve up motions (e.g. 2O, 2Q) are paired to a sliding pitch change from C to G, though other ascending pitch changes can be used. In the example provided, the note C₄ 416 is played and the notes from C₄ 416 to G₄ 424 are played in a sliding manner which is commonly indicated by a slide or glissando on musical notation for example.

In the example provided, short-curve down motions (e.g. 2B, 3B, 2P, 2R, 1S, 2S, 1a, 3b, 1c, 1d, 3e, 1g, 1o, 3p, 1s, 2s) are paired to a sliding pitch change from E to C, though other descending pitch changes can be used. In the example provided, the note E₄ 420 is played and the notes from E₄ 420 to C₄ 416 are played in a sliding manner which is commonly indicated by a slide or glissando on musical notation for example.

In the example provided, short-curve up motions (e.g. 2o) are paired to a sliding pitch change from C to E, though other ascending pitch changes can be used. In the example provided, the note C₄ 416 is played and the notes from C₄ 416 to E₄ 420 are played in a sliding manner which is commonly indicated by a slide or glissando on musical notation for example.

In the example provided, line-across motions across the bottom of the rectangle 24 (e.g. 4E, 3I, 2L, 3Z, 3z) are paired with a single, relatively low note such as C₄ 416.

In the example provided, line-across motions across the middle of the rectangle 24 (e.g. 3A, 3E, 3F, 3G, 2H, 1e, 1z) are paired with a single, relatively mid-pitch note. In the example provided, the single note E₄ 420 is played in the case of letter formation strokes 3A, 3E, 3F, 3G, 2H, and the single note D₄ 418 is played in the case of letter formation strokes 1e and 1z.

In the example provided, line-across motions across the top of the rectangle 24 (e.g. 2E, 2F, 2I, 3J, 2T, 1Z, 3f, 2t) are paired with a single, relatively high note. In the example provided, the single note G₄ 424 is played in the case of letter formation strokes 2E, 2F, 21, 3J, 2T, and 1Z, and the single note E₄ 420 is played in the case of letter formation strokes 3f and 2t.

In the example provided, top-curve motions located at the middle of the rectangle 24 (e.g. 2e, 3h, 3m, 6m, 3n, 3r) are paired to a sliding pitch change from G to A and back to G, though other ascending-descending pitch changes can be used. In the example provided, the note G₄ 424 is played and the notes from G₄ 424 to A₄ 426 and back to G₄ 424 are played in a sliding manner which is commonly indicated by a slide or glissando on musical notation for example.

In the example provided, top-curve motions located at the top of the rectangle 24 (e.g. 1f) are paired to a sliding pitch change from G to F, though other descending pitch changes can be used. In the example provided, the note G₄ 424 is played and the notes from G₄ 424 to F₄ 422 are played in a sliding manner which is commonly indicated by a slide or glissando on musical notation for example.

In the example provided, bottom-curve motions (e.g. 2J, 2U, 2u) are paired to a sliding pitch change from C to B and back to C, though other descending-ascending pitch changes can be used. In the example provided, the note C₄ 416 is played and the notes from C₄ 416 to B₃ 414 and back to C₄ 416 are played in a sliding manner which is commonly indicated by a slide or glissando on musical notation for example.

In the example provided, low bottom-curve motions that go below the line 50 (e.g. 4g, 2j, 4q) are paired to a sliding pitch change from A to G and back to A, though other descending-ascending pitch changes can be used. In the example provided, the note A₃ 412 is played and the notes from A₃ 412 to G₃ 410 and back to A₃ 412 are played in a sliding manner which is commonly indicated by a slide or glissando on musical notation for example.

In the example provided, dot or point above motions (e.g. 2i, 3j) are paired with a single, solid note of relatively higher pitch, such as G₄ 424 for example.

Due to the specific number and placement of the dots of each letter template discussed above, the dots act as visual landmarks to support spatial placement of the lines during letter formation strokes. With the exception of a few letters (e.g. V, Y, N, Z, X, I, v, x, z, and y), the dot landmarks also do not create the entire letter (for example like a connect-the-dot or dot-to-dot pattern would). In this way, the learner is required to think in order to create the letter correctly. However, even in the letters such as V, Y, N, Z, X, I, v, x, z, or y, the letter template does not include any directionality or cues as to the sequence for using the dots. Thus, the learner is also required to think in order to create these letters correctly.

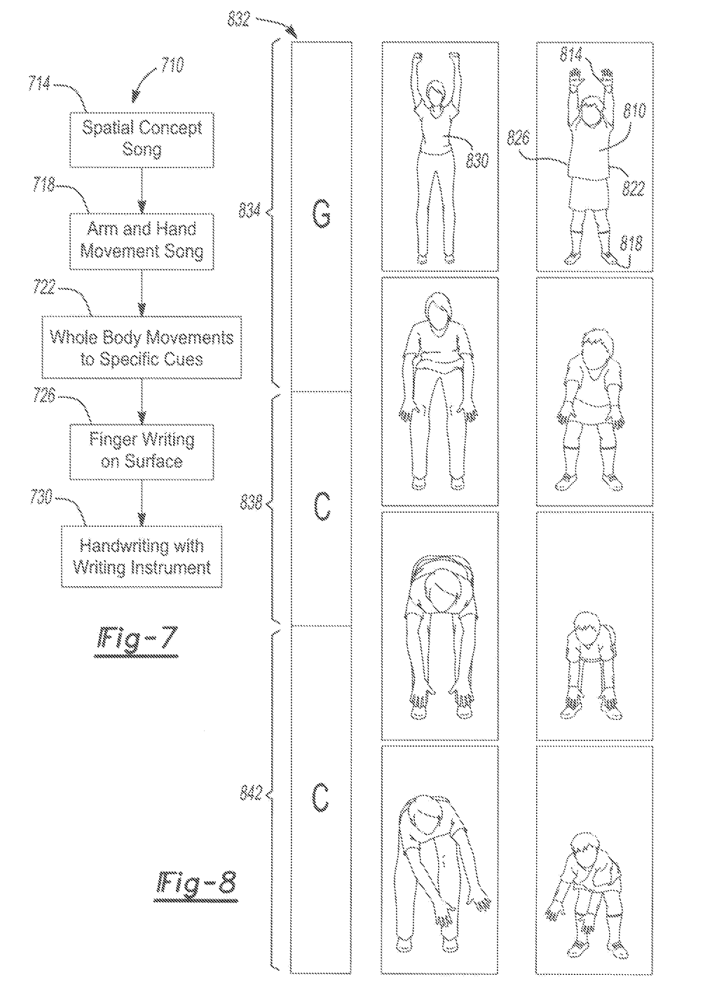

With additional reference to FIG. 7, a method 710 of teaching handwriting is shown in flow chart format. The method 710 can include a plurality of steps and is called the “Connect Experience Write” program or CEW. At step 714, and with additional reference to FIG. 8, a student 810 can be taught, or have reinforced, general spatial concepts such as a top 814, bottom 818, left 822, and right 826 sides of the student's 810 body. These spatial concepts are important foundational concepts of handwriting.

At step 714, an instructor 830 (FIG. 8) can play a first musical song that includes lyrics that state or reinforce the general spatial concepts. The first musical song's lyrics or the instructor 830 can instruct the student 810 to move his/her body in accordance with the general spatial regions stated in the first musical song's lyrics. While listening to the first musical song, the student 810 can follow along to the lyrics and perform the movements described by the lyrics. For example, the first musical song can state movements such as shaking, moving, or waving arms in various directions such as at the top 814 of the student's 810 range of motion, at the bottom 818, to the left 822, and to the right 826. The first musical song can also include other general or broad movements that aid in reinforcement of general spatial concepts.

The first musical song can teach the student 810 to identify the top 814, bottom 818, left 822, and right 826 of the student's 810 body. After the general spatial concepts have been adequately reinforced, the method 710 can proceed to step 718.

It is understood that the mastering of the spatial concepts may occur quickly (e.g. in a single playing of the first musical song), or more gradually (e.g. taking multiple performances of the first musical song). Depending on the student 810, mastering the spatial concepts may occur over an extended period of time (e.g. days or weeks), wherein the exercise of listening to and following along with the first musical song can occur periodically. Alternatively, the student 810 may have already learned the general spatial concepts and the step 714 can be skipped or can be used as a refresher or a warm-up to be immediately followed by step 718.

At step 718, the student 810 (FIG. 8) can be taught, or have reinforced, isolation of more specific regions or areas of the student's 810 body, such as shoulders, elbows, wrists, and fingers for example. At step 718, the instructor 830 can play a second musical song that includes lyrics that state or reinforce the more specific areas of the student's 810 body. The second musical song's lyrics or the instructor 830 can instruct the student 810 to move these more specific areas of his/her body. While listening to the second musical song, the student 810 can follow along to the lyrics and perform the movements described by the lyrics. For example, the second musical song can state finer movements such as reaching up high, moving arms by flexing and extending of the elbows, making and releasing a fist, or flexing the wrists up and down.

The second musical song can teach the student 810 to identify and control the more specific parts of his/her body. After the more specific parts and movements have been adequately reinforced, the method 710 can proceed to step 722.

It is understood that the mastering of the more specific parts of the student's 810 body and movements may occur quickly (e.g. in a single playing of the second musical song), or more gradually (e.g. taking multiple performances of the second musical song). Depending on the student 810, mastering the more specific parts and movements of the student's 810 body may occur over an extended period of time (e.g. days or weeks), wherein the exercise of listening to and following along with the second musical song can occur periodically. Alternatively, the student 810 may have already learned these parts and movements of their bodies and the step 718 can be skipped or can be used as a refresher or a warm-up to be immediately followed by step 722. Thus the learning process from spatial concepts at step 714 to more specific movements at step 718 follows a person's natural coordination development.

At step 722, the student 810 (FIG. 8) can be taught to associate specific audio cues and pitch changes with specific, whole body movements that span the whole range of the student's 810 body, from above the head, to the toes, and as far left and right as the student 810 can reach. Generally, the whole body movements should be similar to the letter formation strokes discussed above with reference to FIGS. 2 and 3.

Specifically, at step 722, one of the letters 14 or 18 (FIG. 2 or 3) can be displayed in front of the student 810 (FIG. 8), such that the student 810 can see the letter throughout the exercises of step 722. The instructor 830 can then play the audio cues while simultaneously performing the whole body movements in front of the student 810. The student 810 is instructed to mirror the instructor's 830 whole body movements while the audio cues are played, thereby activating the brain regions important to learning and associating the movements with the audio cues.

In the example shown in FIG. 8, the instructor 830 and student 810 are performing whole body movements for the letter L. As discussed with reference to FIG. 2, the letter L includes a tall-line down letter formation stroke 1L and a line-across the bottom letter formation stroke 2L. As discussed with reference to FIG. 5, the letter L is paired with a set of audio cues 832. Specifically, the tall-line down letter formation stroke 1L is paired with a G to C pitch change, and the line across the bottom letter formation stroke 2L is paired with a single note C.

Accordingly, as shown in FIG. 8, when the note G 834 is played, the instructor 830 (and the student 810 mirroring the instructor 830) holds his/her hands high above his/her head to start at the top of his/her range of motion. As the pitch changes from the G note 834 to the C note 838, the instructor 830 (and the student 810 mirroring the instructor 830) moves his/her body throughout its whole range of motion in a tall-line down motion until his/her hands are near his/her feet. As the next C note 842 is played, the instructor 830 (and the student 810 mirroring the instructor 830) move his/her arms along the bottom of his/her body to make a line-across motion.

In the example provided, the instructor 830 is facing the student 810 and thus move his/her body in the opposite left/right directions from the actual letter formation strokes so that when the student 810 mirrors the instructor's 830 motions, the student 810 moves in the correct left/right direction. While the example provided shows the instructor 830 facing the student 810 and the student 810 mirroring the instructor 830, other methods of introducing the audio cues 832 and whole body movements can be used, such as the student 810 watching a video for example.

While the letter L is used as an example, it is understood that the other letters 14, 18 are to be performed similarly with whole body movements that mimic the letter formation strokes discussed above with reference to FIGS. 2 and 3, and paired with the notes described above with reference to FIGS. 5 and 6. The letters 14, 18 can be introduced in the order described above with reference to FIGS. 2 and 3, which follow the developmental learning patterns of vertical and horizontal lines first, followed by curves, followed by diagonal lines. After the whole body movements have been adequately associated with the audio cues 832, the method 710 can proceed to step 726.

At step 726, the student 810 (FIG. 8) can be taught to move his/her whole arm (e.g. moving at the shoulder and/or elbow) to the audio cues taught in step 722. As shown in FIG. 9, a large letter template 910 for one of the letters 14, 18 can be placed or displayed on a generally vertical surface in front of the student 810. The large letter template 910 can be similar to the letter templates 22 discussed with reference to FIGS. 2 and 3. Generally, the audio cue for the letter can be played while the student 810 moves his/her arm to trace the letter formation strokes of that letter on the large letter template 910 with his/her finger 914. Alternatively, the student 810 can trace the letter formation strokes of that letter on the large letter template 910 with his/her whole hand or multiple fingers if the student cannot isolate his/her individual finger 914.

In the example shown in FIG. 9, the student 810 is shown performing the arm/finger movements for the letter L. As discussed with reference to FIG. 2, the letter L includes a tall-line down letter formation stroke 1L and a line-across the bottom letter formation stroke 2L. As discussed with reference to FIG. 5, the letter L is paired with the set of audio cues 832. Specifically, the tall-line down letter formation stroke 1L is paired with a G to C pitch change, and the line across the bottom letter formation stroke 2L is paired with a single note C.

Accordingly, as shown in FIG. 9, when the note G 834 is played, the student 810 moves his/her whole arm to point with his/her finger 914 to the top left corner of the large letter template 910. As the pitch changes from the G note 834 to the C note 838, the student 810 can move his/her finger 914 vertically down to the lower left corner of the large letter template 910 to form the tall-line down letter formation stroke 1L. As the next C note 842 is played, the student 810 can move his/her finger 914 along the bottom of the large letter template 910 to form the line-across letter formation stroke 2L.

While the letter L is used as an example, it is understood that the other letters 14, 18 are to be performed similarly on large letter templates with whole arm movements that mimic the letter formation strokes discussed above with reference to FIGS. 2 and 3, and paired with the notes described above with reference to FIGS. 5 and 6. The letters 14, 18 can be introduced in the order described above with reference to FIGS. 2 and 3, which follow the developmental learning patterns of vertical and horizontal lines first, followed by curves, followed by diagonal lines. After the student 810 has mastered the whole arm movements with the audio cues 832, the method 710 can proceed to step 730.

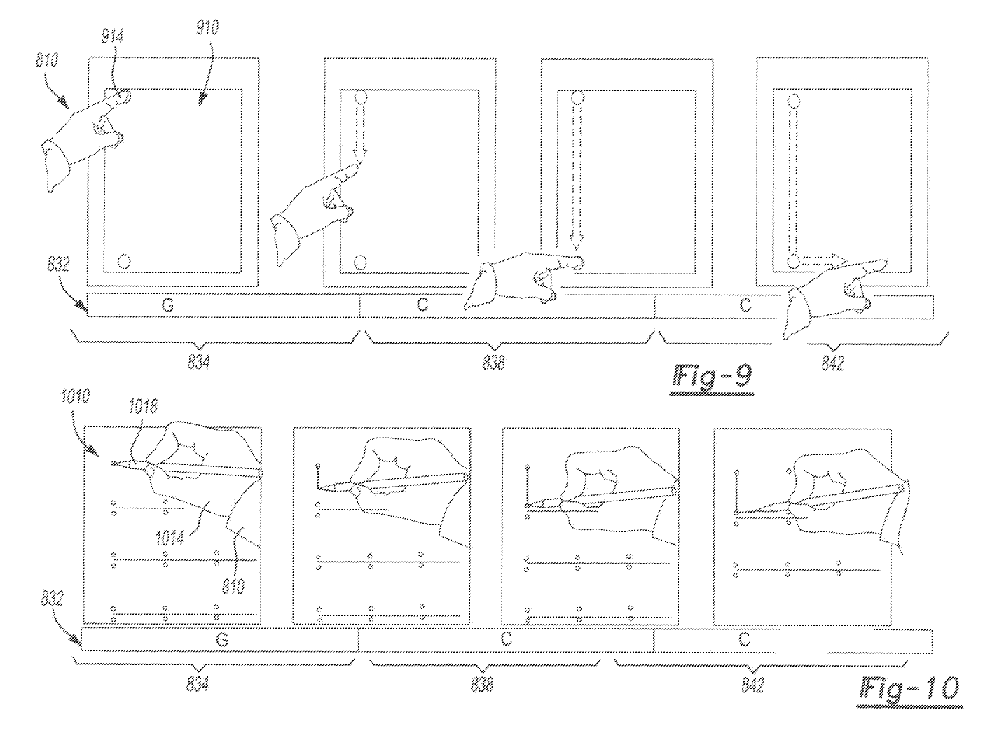

At step 730, the student 810 (FIG. 8) can be taught to move his/her hand with a handwriting instrument to the audio cues taught in step 722 and reinforced in step 726. As shown in FIG. 10, a small letter template 1010 for one of the letters 14, 18 can be placed or displayed on a generally horizontal surface in front of the student 810. The small letter template 1010 can be similar to the letter templates 22 discussed with reference to FIGS. 2 and 3. Generally, the audio cue for the letter can be played while the student 810 moves his/her hand 1014 to write the letter formation strokes of that letter on the small letter template 1010 with a writing instrument 1018 (e.g. a pencil, pen, etc). In this way, the method 710 progresses in the same manner as the student's 810 natural development by starting with whole body, gross motor movements, continuing to arm movements on a vertical surface, and finishing with handwriting on a horizontal surface.

In the example shown in FIG. 10, the student 810 is shown performing the handwriting movements for the letter L. As discussed with reference to FIG. 2, the letter L includes a tall-line down letter formation stroke 1L and a line-across the bottom letter formation stroke 2L. As discussed with reference to FIG. 5, the letter L is paired with the set of audio cues 832. Specifically, the tall-line down letter formation stroke 1L is paired with a G to C pitch change, and the line across the bottom letter formation stroke 2L is paired with a single note C.

Accordingly, as shown in FIG. 10, when the G note 834 is played, the student 810 moves his/her hand 1014 to move the writing instrument 1018 to the top left corner of the small letter template 1010. As the pitch changes from the G note 834 to the C note 838, the student 810 can move the writing instrument 1018 vertically down to the lower left corner of the small letter template 1010 to write the tall-line down letter formation stroke 1L. As the next C note 842 is played, the student 810 can move the writing instrument 1018 along the bottom of the small letter template 1010 to write the line-across letter formation stroke 2L.

While the letter L is used as an example, it is understood that the other letters 14, 18 are to be performed similarly on small letter templates with handwriting movements that follow the letter formation strokes discussed above with reference to FIGS. 2 and 3, and paired with the notes described above with reference to FIGS. 5 and 6. The letters 14, 18 can be introduced in the order described above with reference to FIGS. 2 and 3, which follow the developmental learning patterns of vertical and horizontal lines first, followed by curves, followed by diagonal lines.

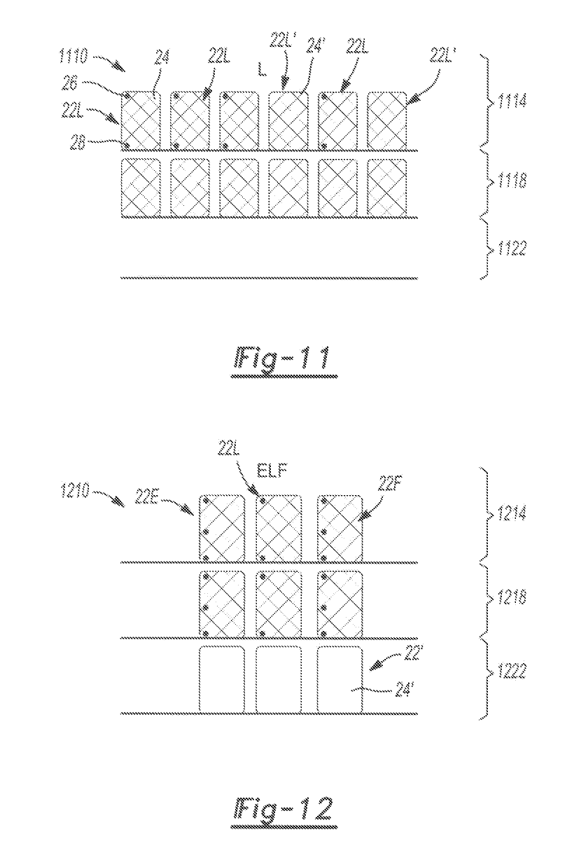

With additional reference to FIG. 11, an example of a progressive letter template is shown and indicated by reference numeral 1110. The progressive letter template 1110 can be used in place of the small letter template 1010 (FIG. 10) during step 730 (FIG. 7). The progressive letter template 1110 can include a plurality of small letter templates 22 that can fade away to trigger learning. Additionally or alternatively, the audio cues (e.g. audio cue 832 of FIG. 8) can be faded away to further trigger learning. In the example provided, the progressive letter template 1110 is shown for the letter L and can include a first row 1114, a second row 1118, and a third row 1122, though other configurations can be used.

The first row 1114 can have one or more L templates 22L followed by a modified L template 22L′. The modified L template 22L′ can include the rectangle 24′ similar to rectangle 24, but can include fewer or no dots (e.g. dots 26 and 28). The familiar rectangle 24′ but the lack of dots can trigger the learning areas of the brain to allow the student 810 (FIG. 8) to write the letter in the rectangle 24′ without the visual cues of the dots. After the modified L template 22L′, the first row 1114 can have another instance of the regular L template 22L to reinforce the correct letter formation strokes. The second row 1118 can be a full row of modified L templates 22L′. The third row can be a blank row without a specific letter template.

With additional reference to FIG. 12, a progressive word template 1210 is shown. The progressive word template 1210 can have letter templates of each letter of a specific word on a row. In the example provided, a first row 1214 has the letter templates 22E, 22L, and 22F to spell the word ELF. In the example provided, a second row 1218 repeats the templates 22E, 22L, and 22F, and a third row 1222 includes modified templates 22′ that have the rectangle 24′ and no dots.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method of teaching handwriting to a student, the method comprising:
playing a first audio cue from a plurality of different audio cues, each audio cue including at least one musical note and corresponding to a specific one of a plurality of letter formation strokes; and
instructing the student to perform a first movement in response to the student hearing the first audio cue, the first movement corresponding to a first one of the letter formation strokes.

2. The method of claim 1, wherein the first audio cue and first movement includes one of the following:
a) a first note followed by a second note, the second note being a lower pitch than the first note, wherein the first movement and the first letter formation stroke are downward motions;
b) a first note followed by a second note, the second note being a higher pitch than the first note, wherein the first movement and the first letter formation stroke are upward motions;
c) a first note followed by a second note that is lower in pitch than the first note, the first audio cue sliding sequentially in pitch from the first note to the second note, wherein the first movement and the first letter formation stroke are curved down motions;
d) a first note followed by a second note that is higher in pitch than the first note, the first audio cue sliding sequentially in pitch from the first note to the second note, wherein the first movement and the first letter formation stroke are curved up motions;
e) a single note, wherein the first movement and the first letter formation stroke are line across motions;
f) a first note followed by a second note that is lower in pitch than the first note, the first audio cue sliding sequentially in pitch from the first note to the second note and then back to the first note, wherein the first movement and the first letter formation stroke are bottom curve motions; or
g) a first note followed by a second note that is higher in pitch than the first note, the first audio cue sequentially including the first note, then the second note, and then the first note, wherein the first movement and the first letter formation stroke are top curve motions.

3. The method of claim 1, wherein the first audio cue includes a first note followed by a second note, the second note being at least two pitches lower than the first note, and the first movement and the first letter formation stroke are either a line down motion or a diagonal down motion.

4. The method of claim 1, wherein the first audio cue includes a first note followed by a second note, the second note being at least two pitches higher than the first note, and the first movement and the first letter formation stroke are either a line up motion or a diagonal up motion.

5. The method of claim 1, wherein the first movement includes the student moving at least his/her whole upper body.

6. The method of claim 1, wherein the first movement includes the student moving a finger or a hand on a letter template.

7. The method of claim 1, wherein the first movement includes the student marking a letter template with a handwriting instrument.

8. The method of claim 1, wherein the first movement includes the student moving at least his/her whole upper body, and the method further comprises:
repeating the first audio cue after the student has performed the first movement; and
instructing the student to perform a second movement in response to the student hearing the first audio cue, the second movement including the student moving a finger on a letter template.

9. The method of claim 8, further comprising:
repeating the first audio cue after the student has performed the second movement; and
instructing the student to perform a third movement in response to the student hearing the first audio cue, the third movement including the student marking a letter template with a handwriting instrument.

10. The method of claim 9, further comprising:
playing a first song prior to the step of playing the first audio cue, the first song having lyrics including top, bottom, left, and right spatial positions of the student's body; and
instructing the student to make whole body movements that correspond to the lyrics of the first song.

11. The method of claim 10, further comprising:
playing a second song after the student has made whole body movements that correspond to the lyrics of the first song and prior to the step of playing the first audio cue, the second song having lyrics including developmental movements of the student's hands and arms.

12. A method of teaching handwriting to a student, the method comprising:
introducing the student to an alphabet letter;
introducing the student to a set of audio cues, each audio cue corresponding to one of a set of handwriting formational strokes of the alphabet letter and including at least one musical note;
introducing the student to a set of body movements simultaneously with the set of audio cues, each body movement involving at least a whole upper body of the student and mimicking the handwriting formational strokes of the alphabet letter, each of the audio cues corresponding to one of the body movements;
instructing the student to perform a corresponding one of the body movements when the student hears a corresponding one of the audio cues; and
playing the set of audio cues while the student performs the body movements.

13. The method of claim 12, further comprising:
playing the set of audio cues while simultaneously introducing the student to a set of arm movements, each arm movement involving the student moving a single arm and mimicking the handwriting formational strokes of the alphabet letter, each audio cue corresponding to one of the arm movements;
instructing the student to perform a corresponding one of the arm movements when the student hears a corresponding one of the audio cues; and
playing the set of audio cues while the student performs the set of arm movements.

14. The method of claim 13, wherein the set of arm movements includes the student moving a finger along a path of the alphabet letter on a large letter template.

15. The method of claim 14, wherein the large letter template is positioned upright in front of the student.

16. The method of claim 14, wherein the large letter template includes a rectangle and a plurality of dots disposed within the rectangle and along the path of the alphabet letter.

17. The method of claim 13, further comprising:
playing the set of audio cues while simultaneously introducing the student to a set of handwriting movements, each handwriting movement involving the student moving a handwriting instrument in a corresponding one of the handwriting formational strokes to mark a writing surface, each audio cue corresponding to one of the handwriting movements;
instructing the student to perform a corresponding one of the handwriting movements when the student hears a corresponding one of the audio cues; and
playing the set of audio cues while the student performs the set of handwriting movements.

18. The method of claim 17, wherein the set of handwriting movements includes the student writing the alphabet letter on a small letter template that includes a rectangle and a plurality of dots disposed within the rectangle along a path of the alphabet letter.

19. The method of claim 12, wherein the handwriting formational strokes and audio cues correspond in at least one of the following ways:
a) downward handwriting formational strokes correspond with an audio cue that includes at least two musical notes sequentially decreasing in pitch;
b) upward handwriting formational strokes correspond with an audio cue that includes at least two musical notes sequentially increasing in pitch;
c) horizontal handwriting formational strokes correspond with an audio cue that includes a single musical note; and
d) curved handwriting formational strokes correspond with an audio cue that slides between at least two musical notes.

20. The method of claim 12, wherein the step of introducing the student to the set of body movements includes an instructor performing the set of body movements simultaneously with the set of audio cues, and the step of instructing the student to perform a corresponding one of the body movements includes instructing the student to mimic the instructor as the instructor performs the set of body movements.
